(19) United States
(12) Patent Application Publication
(10) Pub. No.: US 2003/0082100 A1
(43) Pub. Date: May 1, 2003

(54) Alumina spheres having a high impact resistance

(75) Inventors: Frederic Kolenda, Chaponost (FR); Nathalie Brunard, Chaponost (FR); Charlotte Couroyer, Lyon (FR); Mojtaba Ghadiri, Wirral (GB)

Correspondence Address: MILLEN, WHITE, ZELANO & BRANIGAN, P.C., 2200 CLARENDON BLVD., SUITE 1400, ARLINGTON, VA, 22201, US

(73) Assignee: Institut Francais du Petrole, Rueil Malmaison Cedex (FR)

(21) Appl. No.: 10/274,443

(22) Filed: Oct. 21, 2002

Related U.S. Application Data
(63) Continuation-in-part of application No. 10/126,971, filed on Apr. 22, 2002.

(30) Foreign Application Priority Data
Apr. 20, 2001 (FR) 01/05.414

(51) Int. Cl. C01F 7/02

(52) U.S. Cl. 423/625

(57) ABSTRACT

Porous spheroidal alumina particulate solids that comprise an alumina filler in an amount of about 0.1% to about 25% by weight of Al₂O₃ and have a mechanical resistance to shocks measured by spheres impacting against a target at the speed of 20 m/s such that the fines fragmentation percentage, of a size of less than 50% of the average size of the initial spheres, is less than 5% by weight. Preparation of these spheres by coagulation in drops from an oil-in-water-type emulsion. Application of these spheres as a catalyst substrate or as an adsorbent.

This application is a CIP of application Ser. No. 10/126,971 filed Apr. 22, 2002 claiming priority of French application No. 01/05.414 filed Apr. 20, 2001.

This invention relates to porous spheroidal alumina solids, hereinafter referred to as “spheres” that have improved mechanical properties as well as the application of said alumina spheres. This invention also relates to a process for the production of these porous alumina spheres that are shaped by coagulation in drops and that have improved shock resistance relative to spheres that are produced according to the processes that are described in the prior art. This invention also relates to the spheres that are obtained according to this process and also the applications of these spheres, in particular as an adsorbent or as a catalyst substrate. Since these solids are usually used in moving-bed or boiling-bed or circulating-bed catalytic reactors, the shock resistance of the solids is a primary criterion for the selection of these solids and therefore in the selection of the production method that makes it possible to obtain them. This invention relates further to the means for improving the mechanical resistance to the shocks that is measured by a suitable test, called a target impact test, that is described in particular in detail in an article that appeared at the beginning of 2000 in the journal Oil and Gas Science and Technology Volume 55, Issue 1, pages 67 to 85 with the experimental equipment being presented on page 74 of this article.

Upon further study of the specification and appended claims, further objects and advantages of this invention will become apparent to those skilled in the art.

The technique for shaping by coagulation in drops makes possible the production of a drop of calibrated size, whereby the solidification of this drop by passage into a column usually contains an organic phase and an aqueous phase, the drying of the gel spheres thus formed and the high-temperature calcinations to adjust the porosity and the mechanical resistance of the alumina gel spheres that are thus formed.

The process for coagulation in drops has been the subject of a large number of descriptions both in the technical literature and in numerous patent documents. By way of example of this process for the production of alumina spheres, are the processes described in patent documents EP 15801 and U.S. Pat. No. 4,514,511. According to the description of the U.S. Pat. No. 4,514,511, the problem that it is sought to resolve is obtaining alumina spheres by shaping by coagulation in drops that makes it possible to obtain spheres that have a very low attrition loss, a total pore volume that is larger than that of the spheres obtained according to the prior processes without this degrading their solidity. According to the method that is described in this U.S. Patent, an aqueous alumina suspension or dispersion that comes in the form of an oil-in-water-type emulsion is shaped by coagulation in drops; said alumina suspensions or dispersions preferably contain an alumina filler whose proportion can go up to 90% by weight expressed in Al₂O₃ relative to the total alumina.

The problem that this invention aims to solve consists in finding a method for the production of porous alumina spheres that are shaped by coagulation in drops which results in spheres having a high mechanical resistance to impacts and more particularly a more significant resistance to impacts than that of the spheres that contain filler obtained according to the method that is described and exemplified in U.S. Pat. No. 4,514,511.

In its broader definition, this invention relates to porous alumina spheres that comprise an alumina filler in an amount of about 0.1% to about 25% by weight of Al₂O₃, having a mechanical resistance to impacts that is measured by spheres impacting against a target at the speed of 20 m/s such that the fines fragmentation percentage, smaller in size than 50% of the average size of the initial spheres, is less than 5% by weight. By way of a nonlimiting example in the case where the initial spheres have an average size of 2 millimeters, the fine fragmentation percentage of a size of less than 1 millimeter is less than 5% by weight. This example is one of the preferred embodiments of the invention. The filler is most often selected from the group that is formed by hydrargillite, bayerite, boehmite, pseudo-boehmite, amorphous gels, so-called transition aluminas that comprise at least one phase that is taken from the group that comprises the rhô, chi, eta, gamma, kappa, theta, delta and alpha phases, the alumina particles that are obtained by grinding and optionally sieving of a shaped alumina element that has a size of about 1 to about 50 microns. The spheres of this invention usually have a specific surface area of about 100 to about 400 m²/g and a total pore volume of about 0.3 to about 3 cm³/g. The spheres according to another particular embodiment of the invention can also contain at least one powder of at least one element of groups I_{B}, II_{B}, III_{B}, IV_{B}, V_{B}, VI_{B}, VII_{B}, I_{A}, II_{A}, III_{A}, IV_{A}, V_{A}, VI_{A}, VII_{A}, and VIII.

The preferred characteristics of the spheres according to this invention are described in detail below within the framework of the preferred method for preparation of these spheres.

According to this invention, the process for the production of alumina spheres, comprises shaping by coagulation drops of an aqueous alumina suspension or dispersion, most often in the form of an oil-in-water-type emulsion, recovering the spheres that are formed, drying and calcining of said spheres in which the suspensions or dispersions also contain at least one alumina filler in a ratio of about 0.1% to about 25% by weight expressed in Al₂O₃ relative to the total alumina. According to a particular implementation of this invention, the filler represents about 1% to about 20% and most often from about 5% to about 20% by weight expressed in Al₂O₃ relative to the total alumina. In the latter ratio expression, the term Al₂O₃ refers to the corresponding weight of Al₂O₃ formula compound obtained after calcination of the filler.

The spheres that are obtained according to the process of this invention have a high shock resistance, greater than those that are obtained by using the methods that are described in the prior art cited above. These spheres in particular can be used as a catalyst, as a catalyst substrate and also as an adsorbent. The processes for the production of alumina spheres of the type comprising the shaping by coagulation in drops of a suspension or a dispersion or an alumina aqueous dispersion, recovery of the formed spheres, drying and calcination are processes that are well known to one skilled in the art and have been broadly described in the literature. It is thus possible, for example, to refer to the description of the documents of the prior art that are cited in this description whose teaching should be considered as an integral part of this description simply by the fact of their being mentioned.

This process usually comprises the mixture at an acid pH, i.e., lower than (pH<7) of an ultra-fine boehmite sol or pseudo-boehmite sol with alumina particles forming the filler in a ratio that is determined as indicated above. The concentration expressed by weight of alumina Al₂O₃ of the suspension, the dispersion or the solution and in particular in the case of a boehmite sol or a pseudo-boehmite sol made of solid material is usually from about 5% to about 30%. The alumina particles, also called filler within the framework of this description, can be any alumina compound that is known to one skilled in the art. Most often, the filler is selected from the group that is formed by hydrargillite, bayerite, boehmite, pseudo-boehmite, amorphous gels, so-called transition aluminas, that comprise at least one phase that is taken from the group comprising the rhô, chi, eta, gamma, kappa, theta, delta and alpha phases. It is also possible to use as a filler any alumina particle that is obtained by grinding and optionally sieving of a shaped alumina element. The specific surface area is usually from about 100 to about 400 m²/g. The size of the alumina particles selected as a can vary within broad limits, but it is most often from about 1 to about 50 microns. The acid pH is usually obtained by wetting these alumina oxides by an aqueous solution of a mineral acid or organic acid. Often, as is further mentioned in U.S. Pat. No. 4,514,511, the processes that are described in U.S. Pat. No. 3,520,654, FR-A-2221405, GB-A-888772, U.S. Pat. No. 3,630,670, FR-A-1108011, and EP-A-15196 will be used for the preparation of the alumina filler used in this invention.

When catalysts comprising substrates of very pure alumina are produced within the framework of this invention, it is preferred to use alumina fillers that are obtained by drying followed by a calcination of aqueous suspensions or dispersions of boehmite or ultra-pure pseudo-boehmite preferably obtained from aluminum hydroxide gels that have themselves been prepared by hydrolysis of aluminum alcoholates.

According to a variant of the process for the production of alumina spheres according to the invention, it is possible to mix with the alumina suspension or dispersion at least one powder of at least one element of groups I_{B}, II_{B}, III_{B}, IV_{B}, V_{B}, VI_{B}, VII_{B}, I_{A}, II_{A}, III_{A}, IV_{A}, V_{A}, VI_{A}, VII_{A}, and VIII of the periodic table, whereby these powders can be metals or elements themselves, their oxides, their insoluble salts, their solid solutions and the mixed oxides of the latter.

According to another variant of the process for the production of alumina spheres according to the invention, it is possible to replace a portion of the initial alumina suspension or dispersion by at least one sol, when it exists, of at least one element of groups I_{B}, II_{B}, III_{B}, IV_{B}, V_{B}, VI_{B}, VII_{B}, I_{A}, II_{A}, III_{A}, IV_{A}, V_{A}, VI_{A}, VII_{A}, and VIII of the periodic table. It is also possible to mix the initial suspension or dispersion with various salts and in particular with at least one soluble salt of the elements of groups I_{B}, II_{B}, III_{B}, IV_{B}, V_{B}, VI_{B}, VII_{B}, I_{A}, II_{A}, III_{A}, IV_{A}, V_{A}, VI_{A}, VII_{A}, and VIII of the periodic table.

According to the process of the invention, the aqueous alumina suspension or dispersion that contains an alumina filler can be most often an oil-in-water-type emulsion. A surfactant is most often added to facilitate the dispersion of the organic phase into the aqueous medium. The production of the emulsion is usually obtained by vigorous stirring of the aqueous alumina suspension that contains the filler in the presence of the organic phase and most often the emulsifier or surfactant. The proportion of the organic phase in the aqueous phase (whereby the aqueous phase is shown by the free water that is present in the emulsion) is usually between (inclusive) about 0.5 and about 40% by weight. This mixture or suspension or emulsion is then shaped by draining it by gravity through an orifice of calibrated size, then passage of the drops that are thus formed into a column that contains an upper phase that consists of an organic phase that can be petroleum or a petroleum fraction (kerosene, gas oil) and a lower aqueous phase that consists of an ammonia solution. The drops solidify by coagulation during their retention in the ammoniacal phase. Under these conditions, the collected spheres are solid enough to be transported, then dried and calcined at a temperature that is most often between (inclusive) 500 and 1000° C.

The boehmite or pseudo-boehmite sol is obtained by contact between acid aqueous solution and a boehmite powder. This boehmite can be obtained from processes that are well known to one skilled in the art: precipitation of an alkaline aluminate by an acid solution as is described in, for example, U.S. Pat. No. 3,630,670, precipitation of an aluminum acid salt by a base as is described in, for example, Applied Industrial Catalysis, Volume 3, Chapter 4, pages 87 to 94 by precipitation of an aluminate with an acid salt of acidic aluminum as is described in, for example, Applied Industrial Catalysis, Volume 3, Chapter 4, pages 87 to 94 by hydrolysis of acid aluminum alcoholates as is described in, for example, U.S. Pat. No. 2,892,858, by precipitation of an alkaline aluminate with the carbonic anhydride as is described in, for example, U.S. Pat. No. 3,268,295.

The organic phase of the emulsion should include, preferably for the most part and even solely, products that are not totally water-miscible and that can be eliminated by combustion and liquids at ambient temperature. The latter can be selected from among the dispersed phases that are most commonly encountered industrially, such as mineral fats, oils and waxes, fatty substances, hydrocarbons and petroleum fractions such as kerosene, for example.

The emulsifying agent or surfactant is selected so as to ensure the stability of the emulsion. It should be possible to eliminate it by combustion and liquid at ambient temperature.

The characteristics of the calcined spheres that are produced according to the process of this invention are very broad. These are solids that have a monomodal or bimodal porous structure with a total pore volume that can vary from about 0.3 to about 3 cm³/g, often from about 0.4 to about 1 cm³/g and most often from about 0.45 to about 0.7 cm³/g, with a specific surface area that is usually less than 350 m²/g and often from about 100 to about 350 m²/g. The pore volume of the spheres is characterized by the fact that it comprises closed macropores, i.e., pores that have a diameter of between 0.2 and 15 micrometers that can be accessed by mesopores with an opening of between 20 and 500 angstroms (Å). The amount of closed macropores varies based on the proportion of organic phase that can optionally be used during the preparation phase of the suspension or emulsion.

These solids in sphere shape can be used in numerous catalytic reactions as a catalyst substrate. These solids in sphere shape can also be used in adsorption. The following examples of their use in the field of catalysis are provided as nonlimiting examples: reforming, hydrogenation, isomerization, dismutation, oxychlorination, oxidation/reduction, CLAUS catalyst, i.e., a catalyst that is used in the reaction for transformation of hydrogen sulfide into sulfur.

Their use in catalytic processes that use moving-bed, circulating-bed or boiling-bed reactors imposes on the solids very stringent requirements on mechanical resistance to shocks (between particles and against the inside walls of the reactor).

The most representative test that makes it possible to grasp the fragmentation problems of particles that undergo shocks between substrate or catalyst particles or with metallic surfaces during flow between reactors or in pressurized pneumatic transport lines is the so-called target impact test, described in particular by C. Couroyer, M. Ghadiri, P. Laval, N. Brunard, F. Kolenda, published in Oil & Gas Science and Technology, Volume 55 (2000), No. 1, pages 67 and 85 and shown in a diagram in FIG. 8, page 74 of this article.

This test subjects a large number of particles (about 4000) to shocks at controlled speed on a metallic target or a target that consists of a bed with particles that are identical to the tested particles.

After the test, the recovered particles are sieved. The residue is weighed, and a fragmentation index ξ is calculated from the following equation:

ξ=Mass of residue/initial mass of the impacted sample

This index is defined for a specific speed of impact that is measured during the test and in our case set at 20 m/s.

A criterion for selection of solids is to limit the percentage of fragmentation to a value that is less than 5% by weight of fines that have a size of less than 50% of the average size of the initial spheres.

Examples for Preparation of Alumina Spheres:

A typical preparation follows the following operating procedure:

For 1 liter of water that is used to produce the suspension, the content of mineral material that is expressed by the Al₂O₃/water ratio is kept constant at 24% by weight. The “mineral material” is microcrystalline boehmite or else is called pseudo-bochmite of PURAL 3B type that is provided by the CONDEA Company.

The content of filler is variable between the maximum value of 30% by weight and the absence of filler (0% by weight) as indicated in Table 1 below. The filler is a crystallized alumina, the crystallographic nature of the filler being set forth in Table 1. The filler is ground and brought down to a median size of less than 10 microns. The two alumina powders, i.e., microcrystalline bochmite and crystallized alumina, are suspended in a nitric acid solution that contains an acid content that is expressed by the total pure HNO₃/Al₂O₃ ratio=5.3% by weight.

In this suspension, the organic phase and the surfactant that are necessary for the genesis of the oil-in-water emulsion are added. The respective contents of these two components are provided by the following ratios:

Organic phase/water=variable (see Table 1)

Surfactant/organic phase=2% by weight

The organic phase that is used is isane, a brand name for a kerosene-type petroleum fraction that is sold by the TOTAL Company, and the surfactant is GALORYL EM 10, a non-ionic emulsifying agent that is sold by the Comptoir Francais des Produits Industriels. Table 1 also explains the composition of emulsions that are used during the preparation of alumina spheres. Examples 1, 2 and 11 are comparison examples, and Examples 3 to 10 are examples according to this invention.

After mixing and stirring for about 4 hours, the suspension is drained by means of a calibrated tube. The suspension falls in the form of uniform drops into a column that consists of a portion of a layer of isane and a lower aqueous layer of ammonia with 20 g/l of NH₃. The hydrogel spheres that are thus obtained are dried in an oven at 100° C. for 16 hours and then calcined in a muffle furnace at 600° C. for 2 hours. The mechanical resistance to shocks was measured on the calcined product and appears in the last column of Table 1.

TABLE 1

| | Filler | Type of | | Fines Level |
|---|---|---|---|---|
| | Level % | Alumina of the | | After 1 Impact |
| Example | by Weight | Filler | % Emulsion* | at 20 m/s |
| 1 | 30 | Gamma | 4 | 5.2 |
| 2 | 30 | Gamma | 0 | 7 |
| 3 | 25 | Gamma | 4 | 3 |
| 4 | 25 | Gamma | 0 | 3.5 |
| 5 | 15 | Gamma | 4 | 0.2 |
| 7 | 15 | Gamma | 0 | 0.4 |
| 8 | 15 | Alpha | 4 | 0.1 |
| 9 | 1 | Gamma | 2.7 | 1.3 |
| 10 | 1 | Gamma | 0 | 3.3 |
| 11 | 0 | — | 0 | 6.6 |

*Organic Phase/water

The examination of the results that are obtained shows in a surprising way that a range of critical values of the filler content exists that makes it possible to obtain a sphere breakage rate that is compatible with use in a moving bed or circulating bed. In contrast, for contents of fillers that are less than 25%, the addition of an emulsifier in low contents that are generally less than 10% does not embrittle the particle but rather stabilizes its mechanical resistance to shocks.

The preceding examples can be repeated with similar success by substituting the generically or specifically described reactants and/or operating conditions of this invention for those used in the preceding examples.

The entire disclosure of all applications, patents and publications, cited above and below, and of corresponding French Application No. 01/05.414, filed Apr. 20, 2001 is hereby incorporated by reference.

From the foregoing description, one skilled in the art can easily ascertain the essential characteristics of this invention and, without departing from the spirit and scope thereof, can make various changes and modifications of the invention to adapt it to various usages and conditions.

1. Porous alumina spheres that comprise an alumina filler in an amount of about 0.1% to about 25% by weight of Al₂O₃, based on the total Al₂O₃ exhibiting a mechanical resistance to impacts that is measured by spheres impacting against a target at the speed of 20 m/s such that the fines fragmentation percentage, of a size of less than 50% of the average size of the initial spheres, is less than 5% by weight.

2. Alumina spheres according to claim 1, in which the filler is selected from the group consisting of hydrargillite, bayerite, boehmite, pseudo-boehmite, amorphous gels, so-called transition aluminas comprising at least one phase from the group consisting of rhô, chi, eta, gamma, kappa, theta, delta and alpha phases, whereby the alumina particles that are obtained by grinding and optionally sieving of a shaped alumina element have a size of about 1 to about 50 microns.

3. Alumina spheres according to claim 1, having a specific surface area of about 100 to about 400 m²/g.

4. Alumina spheres according to claim 1, having a total pore volume of about 0.3 to about 3 cm³/g.

5. Alumina spheres according to claim 1, comprising at least one powder of at least one element of groups I_{B}, II_{B}, III_{B}, IV_{B}, V_{B}, VI_{B}, VII_{B}, I_{A}, II_{A}, III_{A}, IV_{A}, V_{A}, VI_{A}, VII_{A}, and VIII of the periodic table.

6. A process for preparation of alumina spheres according to claim 1, comprising shaping by coagulation in drops of an aqueous alumina suspension or dispersion, recovering formed spheres, drying and calcining the spheres, wherein the suspensions or the dispersions also contain at least one alumina filler in a ratio of about 0.1% to about 25% by weight expressed in Al₂O₃ relative to the total alumina.

7. A process according to claim 6, wherein the aqueous alumina suspension or dispersion is in the form of an oil-in-water emulsion.

8. A process according to claim 6, wherein the alumina filler is selected from the group consisting of hydrargillite, bayerite, boehmite, pseudo-boehmite, amorphous gels, transition aluminas comprising at least one phase from the group consisting of the rhô, chi, eta, gamma, kappa, theta, delta and alpha phases, whereby the alumina particles that are obtained by grinding, and optionally sieving of a shaped alumina element have a size of about 1 to about 50 microns.

9. A process according to claim 6, wherein the total concentration of Al₂O₃ of the suspension, the dispersion or the solution is about 5% to about 30% by weight.

10. A process according to claim 7, wherein the oil-in-water-type emulsion comprises an organic phase, an aqueous phase and a surfactant, and the proportion of the organic phase in the aqueous phase is between about 0.5 and about 40% by weight, inclusive.

11. A process according to claim 6, wherein the alumina suspension or dispersion contains at least one powder of at least one element of groups I_{B}, II_{B}, III_{B}, IV_{B}, V_{B}, VI_{B}, VII_{B}, I_{A}, II_{A}, III_{A}, IV_{A}, V_{A}, VI_{A}, VII_{A}, and VIII of the periodic table, said powders being the elements themselves, oxides, thereof insoluble salts, thereof solid solutions thereof and mixed oxides of solid solutions.

12. A process according to claim 6, wherein the alumina suspension or dispersion contains at least one sol of at least one element of groups I_{B}, II_{B}, III_{B}, IV_{B}, V_{B}, VI_{B}, VII_{B}, I_{A}, II_{A}, III_{A}, IV_{A}, V_{A}, VI_{A}, VII_{A}, and VIII of the periodic table.

13. A process according to claim 6, wherein the alumina suspension or dispersion contains at least one soluble salt of the elements of groups I_{B}, II_{B}, III_{B}, IV_{B}, V_{B}, VI_{B}, VII_{B}, I_{A}, II_{A}, III_{A}, IV_{A}, V_{A}, VI_{A}, VII_{A}, and VIII of the periodic table.

14. Alumina spheres according to claim 1, wherein the alumina filler is gamma alumina and the remainder of the Al₂O₃ is microcrystalline boehmite or pseudo-boehmite.

15. Alumina spheres according to claim 1, wherein the alumina filler is alpha alumina and the remainder of the Al₂O₃ is microcrystalline boehmite or pseudo-boehmite.

16. Alumina spheres according to claim 1, produced by a process comprising shaping by coagulation in drops of an aqueous alumina suspension or dispersion, recovering formed spheres, drying and calcining the spheres, wherein the suspensions or the dispersion also contain at least one alumina filler in a ratio of about 0.1% to about 25% by weight expressed in Al₂O₃ relative to the total alumina.

17. Alumina spheres according to claim 14, produced by a process comprising shaping by coagulation in drops of an aqueous alumina suspension or dispersion, recovering formed spheres, drying and calcining the spheres, wherein the suspensions or the dispersions also contain at least one alumina filler in a ratio of about 0.1% to about 25% by weight expressed in Al₂O₃ relative to the total alumina.

18. Alumina spheres according to claim 16, wherein the alumina suspension or dispersion is an oil-water emulsion.

19. Alumina spheres according to claim 17, wherein the alumina suspension or dispersion is an oil-water emulsion.

20. Alumina spheres according to claim 16, wherein the suspension or dispersion comprises a boehmite or pseudo-bochmite sol produced by contacting a boehmite powder with an aqueous acidic solution, said sol being then mixed with a crystallized alumina.
